(19) United States
(12) Patent Application Publication
(10) Pub. No.: US 2007/0209021 A1
(43) Pub. Date: Sep. 6, 2007

(54) Data Input Method And Apparatus

(76) Inventors: Kyle Chien, Ibaraki (JP); Mitsuhiro Aso, Osaka (JP); Daniel Weber, Osaka (JP); Stefan Walter, Adliswil (CH)

Correspondence Address: WENDEROTH, LIND & PONACK L.L.P., 2033 K. STREET, NW, SUITE 800, WASHINGTON, DC, 20006, US

(21) Appl. No.: 10/591,716

(22) PCT Filed: Mar. 24, 2005
(86) PCT No.: PCT/JP05/06206

§ 371 Date: Sep. 6, 2006

(30) Foreign Application Priority Data
Apr. 12, 2004 (JP) 2004-117101

(51) Int. Cl. G06F 3/048

(52) U.S. Cl. 715/808

(57) ABSTRACT

A data input system has a key pad with a plurality of keys and a display. The selected key is displayed in the display, but the character size of the selected key on the display is small and difficult to recognize. The face of the selected key appears on the display as a pop-up display in an enlarged scale. Thus, it is easy to recognize the selected key.

### TECHNICAL FIELD

The present invention relates to a data input method and apparatus. A data input system has a key pad with a plurality of keys and a display for displaying the input data. The present invention provides a pop-up display of a key when a key is touched.

### BACKGROUND ART

Mobile devices and remote control devices nowadays are highly advanced and sophisticated. Mobile devices are for example, cellular phone, PDA (personal digital assistants), notebook type PC (personal computer), while the remote control devices are for example, remote controller for the audio and video appliances. Mobile devices and remote control devices have a plurality of keys in a small area, so that it is difficult for a user to hit the proper key, particularly when the device is used in a dark place. Also since the finger tip usually covers the face of the key, it is difficult to acknowledge which key is touched before depressing. An example of the keys used in a PC is disclosed in Japanese document 2002-323845.

Since the keys provided in the mobile devices and the remote control devices are small in size, it is difficult to find a proper key by just looking onto the key pad. Even when a proper key is found, it is difficult to tell which key one is touching, since the touched key is covered by a finger. Thus, the problem to be solved in the prior art mobile devices and remote control devices is that the touched key can not be visually acknowledged before depressing the key. The mobile devices and the remote control devices may be difficult to use for the old people or for the people with poor eyesight, because the indicators on the keys are small to recognize.

### DISCLOSURE OF INVENTION

The present invention provides a method and an apparatus for improving the accessibility to a proper key provided in the mobile devices and the remote control devices.

According to the present invention, a method for inputting data to a system having a plurality of keys and a display, each key being indicated with a particular visual indicator, comprises: detecting a touch on one of said plurality of keys; displaying on said display, in response to the detection of a touch on one key a pop-up display of a representing information representing the touched key; detecting a depression of the touched key; and entering data assigned to said touched key.

Furthermore, according to the present invention, an apparatus for inputting data to a system having a plurality of keys and a display, each key being indicated with a particular visual indicator, said apparatus comprising: a touch detecting arrangement operable to detect a touch on one of said plurality of keys; a displaying arrangement operable to display on said display, in response to the detection of a touch on one key, a pop-up display of a representing information representing the touched key; a depression detecting arrangement operable to detect a depression of the touched key; and an entering arrangement operable to enter data assigned to said touched key.

According to a preferred embodiment, the representing information is the indicator.

According to a preferred embodiment, the representing information is a number assigned to the key.

According to a preferred embodiment, the representing information is a character assigned to the key.

According to a preferred embodiment, the representing information is a plurality of characters assigned to the key.

According to a preferred embodiment, the representing information is a function assigned to the key.

According to a preferred embodiment, the method further comprises, after data entering, displaying on said display, in response to the detection of depress, a regular display in which the entered data is displayed together with previously entered data.

According to a preferred embodiment, the displaying arrangement further displays on said display, in response to the detection of depress, a regular display in which the entered data is displayed together with previously entered data.

According to a preferred embodiment, the pop-up display is displayed for a predetermined period of time.

The present invention has the following advantageous effects. According to the present invention, since the touched key or the representing information of the key, such as the selected function, appears as a pop-up display in an enlarged scale, such a key can be easily recognized before entering. Thus the key entering can be accomplished with fewer mistakes.

### BRIEF DESCRIPTION OF DRAWINGS

FIG. 1 is a simplified diagram of the input apparatus of the present invention.

FIG. 2 is a block diagram of the input apparatus of the present invention.

FIG. 3 is a diagram showing a pop-up display according to the first embodiment of the invention.

FIG. 4 is a flowchart showing a pop-up display operation according to the first embodiment of the invention.

FIG. 5 is a flowchart showing a pop-up display operation according to the second embodiment of the invention.

FIG. 6 is a flowchart showing a detail of the key function selection shown in FIG. 5.

FIG. 7 is a diagram showing a pop-up display according to the second embodiment of the invention.

FIG. 8 is a diagram showing a pop-up display according to the second embodiment of the invention.

FIG. 9 is a diagram showing a pop-up display according to the second embodiment of the invention.

FIG. 10 is a diagram showing a pop-up display according to a modification of the second embodiment of the invention.

### BEST MODE FOR CARRYING OUT THE INVENTION

### First Embodiment

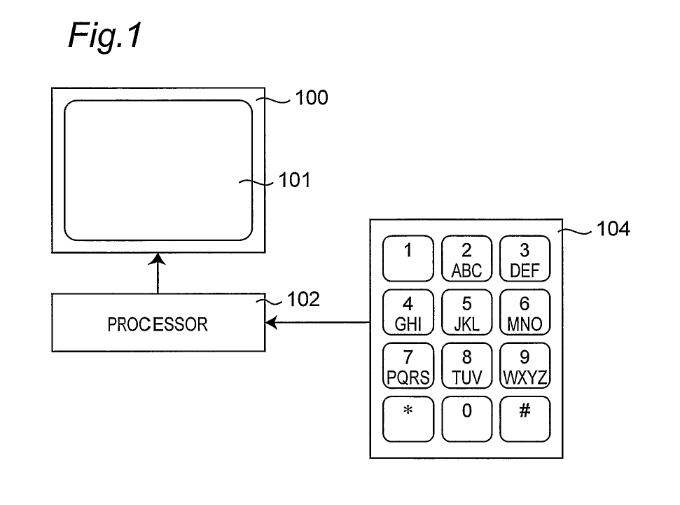

Referring to FIG. 1, a data input apparatus according to the first embodiment of the present invention is shown. The data input apparatus has a display 100, a screen 101, a processor 102 and an input key pad 104 with a plurality of keys. Here, key pad includes key board. Each key is indicated with a particular visual indicator. The data input apparatus can be equipped in a cellular phone or a remote controller for a television, or any other mobile devices and remote control devices defined above. The keys and the display define a system to which data is to be inputted.

In the case of a cellular phone, the key pad 104 has numeral keys 1, 2, 3, 4, 5, 6, 7, 8, 9 and 0, and some function keys, such as “* and #”. According to the first embodiment of the present invention, each key is formed by a two step sensing arrangement, touch sensing and depress sensing. Each key face is coated with a film which can sense the touch of a human finger. Also each key is associated with a switch which is turned on upon depression of the key. Each key is indicated with a particular visual indicator. For example, key 5 has an indicator on its face “5” and “JKL”. Such an indicator may be formed on the face of the key or at a space adjacent the key.

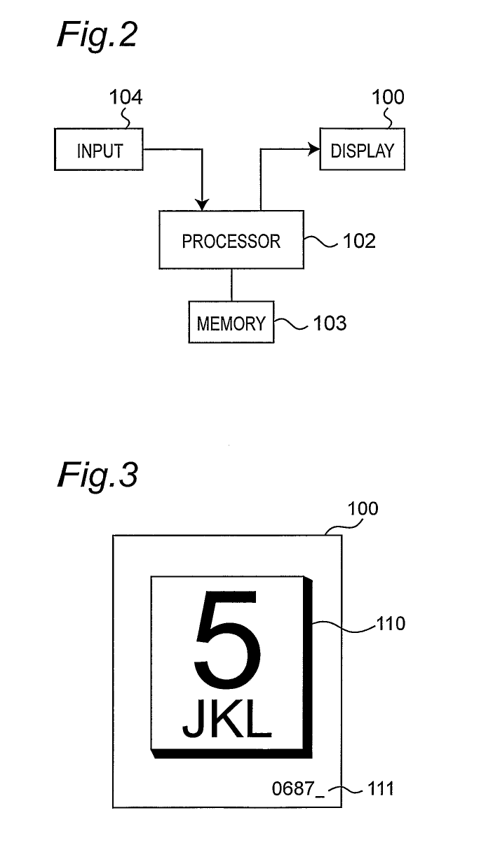

Referring to FIG. 2, a block diagram of the data input apparatus is shown, which comprises the input key pad 104, display 100, processor 102 and memory 103. Memory 103 is stored with a look up table having image data of the indicator provided to each key in the key pad.

Referring to FIG. 3, one example of a pop-up display 110 is shown. The pop-up display 110 shows the indicator of the key that is touched. For example, when a numeral key 5 is touched, a pop-up display 110 of numeral key 5, as shown in FIG. 3, appears on the display 100. The pop-up display 110 shows the indicator of the touched numeral key 5 in an enlarged scale on the display 100. The pop-up display 110 may be enclosed by a rectangular contour line so as to be look similar to the key 5. The display 100 also shows a regular display 111 at which the data that has been entered are shown in an aligned numbers or characters. In other words, in the regular display, the newly entered data is displayed together with previously entered data. The regular display 111 may be located outside the pop-up display 110 or behind the pop-up display 110.

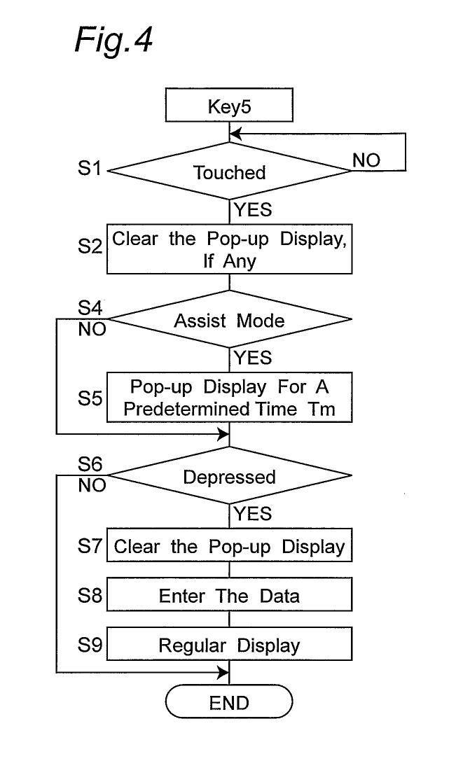

Referring to FIG. 4, a flowchart is shown for showing the pop-up display 110 of numeral key 5.

At step S1, it is detected whether or not key 5 is touched.

At step S2, if any pop-up display is remaining in the display 100, it is cleared.

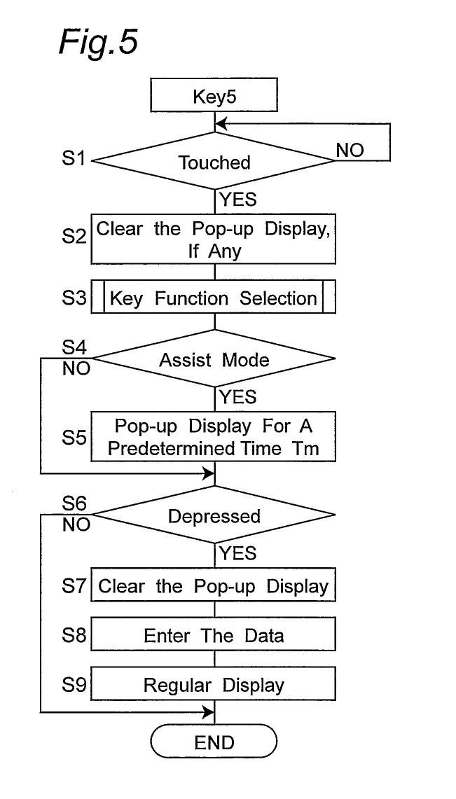

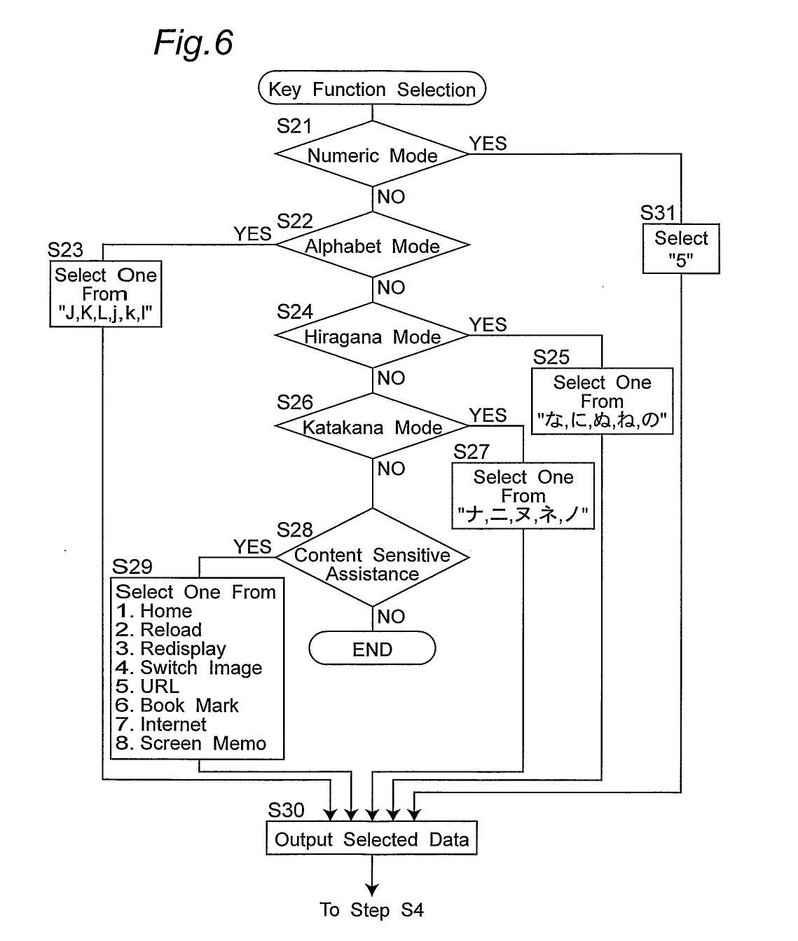

Step S3 is not included in the first embodiment, because step S3 pertains to the second embodiment, and will be described later in connection with FIGS. 5 and 6.

At step S4, it is detected whether or not an assist mode is set. When the assist mode is set, the pop-up display occurs in addition to the regular display, and when the assist mode is not set, the pop-up display will not occur, but only the regular display occurs.

At step S5, the pop-up display 110 is shown in the display 100 for a predetermined time Tm after step S5.

At step S6, it is detected whether or not the touched key 5 is depressed.

At step S7, when the touched key is depressed, the pop-up display is cleared.

At step S8, the data assigned to the depressed key is entered. For example, the data assigned to key 5 may be number 5, or any one of the character, such as J, K, L, j, k or l, or some other representing information which will be described later.

At step S9, the regular display is carried out to show a series of input data that has been entered.

Although FIG. 4 shows the flowchart for numeral key 5, a similar flowchart exists for each of other keys in the key pad.

### Second Embodiment

Referring to FIGS. 5 and 6, flowcharts are shown for showing the pop-up display 110 according to the second embodiment. The flowchart of FIG. 5 differs from the flowchart of FIG. 4 such that a subroutine step S3 is further added. The flowchart of FIG. 6 shows the detail of the subroutine step S3. Before explaining the detail of the flowcharts of FIGS. 5 and 6, the function of the keys under different modes are described.

In the case of a cellular phone, the keys 1, 2, 3, 4, 5, 6, 7, 8, 9 and 0 are assigned, respectively, with numbers 1, 2, 3, 4, 5, 6, 7, 8, 9 and 0 under a numeral mode.

When the key mode is changed to some other mode, the keys 1, 2, 3, 4, 5, 6, 7, 8, 9 and 0 are assigned with characters or functions. For example, when an alphabet mode is selected, the keys are assigned with alphabets, as shown in Table 1 below.

TABLE 1

| numeral key | assigned character |
|---|---|
| 1 | (none) |
| 2 | A, B, C, a, b, c |
| 3 | D, E, F, d, e, f |
| 4 | G, H, I, g, h, i |
| 5 | J, K, L, j, k, l |
| 6 | M, N, O, m, n, o |
| 7 | P, Q, R, S, p, q, r, s |
| 8 | T, U, V, t, u, v |
| 9 | W, X, Y, Z, w, x, y, z |
| 0 | (none) |

In the case of a Japanese cellular phone, a hiragana mode and a katakana mode are available. For example, when a hiragana mode is selected, the keys are assigned with hiragana, as shown in Table 2 below.

TABLE 2

| numeral key | assigned character |
|---|---|
| 1 | [symbol] |
| 2 | [symbol] |
| 3 | [symbol] |
| 4 | [symbol] |
| 5 | [symbol] |
| 6 | [symbol] |
| 7 | [symbol] |
| 8 | [symbol] |
| 9 | [symbol] |
| 0 | [symbol] |

When a katakana mode is selected, the keys are assigned with katakana, as shown in Table 3 below.

TABLE 3

| numeral key | assigned character |
|---|---|
| 1 | [symbol] |
| 2 | [symbol] |
| 3 | [symbol] |
| 4 | [symbol] |
| 5 | [symbol] |
| 6 | [symbol] |
| 7 | [symbol] |
| 8 | [symbol] |
| 9 | [symbol] |
| 0 | [symbol] |

Furthermore, when the cellular phone enters a menu de or a function mode, the keys are assigned with different functions, as shown in Table 4 below.

TABLE 4

| numeral key | assigned function |
|---|---|
| 1 | Home |
| 2 | Reload |
| 3 | Redisplay |
| 4 | Switch Image |
| 5 | URL |
| 6 | Book Mark |
| 7 | Internet |
| 8 | Screen Memo |
| 9 | Mail |
| 0 | Message |

The functions are listed as an example, and the function itself is not of importance according to the present invention. The important point is that the numeral key is assigned with a particular function.

According to the second embodiment, the pop-up display shows not the indicator, such as the face of the key, but a character or a function assigned to the key.

Referring to FIG. 5, a flowchart for key 5 is shown.

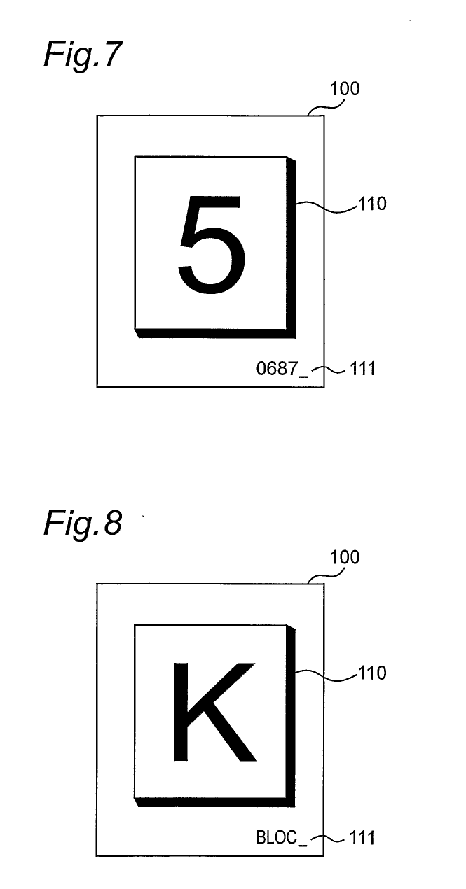

At step S3, when key 5 is touched, a character or a function assigned to the key 5 is selected. Under the numeral mode, the key 5 is assigned with a number 5. Thus, a pop-up display 110 of “5” as shown in FIG. 7 appears on display 100. Under the alphabet mode, the key 5 is assigned with one of alphabets “J, K, L, j, k, I” which change after each touch of the key 5. When key 5 is touched for the first time after setting the numeric mode, a pop-up display 110 of “J” appears. When key 5 is touched for the second time, a pop-up display 110 of “K” appears. When key 5 is touched for the third time, a pop-up display 110 of “L” appears. When key 5 is touched for the fourth time, a pop-up display 110 of “j” appears. When key 5 is touched for the fifth time, a pop-up display 110 of “k” appears. When key 5 is touched for the sixth time, a pop-up display 110 of “l” appears. This cycle is repeated if key 5 is touched further number of times.

Referring to FIG. 6, a detail of the key function selection step S3 is shown.

At step S21, it is detected whether or not the set mode is a numeral mode.

At step S31, since the flowchart is for key 5, a number 5 is selected.

At step S22, it is detected whether or not the set mode is an alphabet mode.

At step S23, one alphabet is selected from a plurality of alphabets assigned to key 5. For example, when key 5 is touched for the first time after setting of the alphabet mode, “J” is selected. When key 5 is touched for the second time, “K” is selected, and so on. A counter is provided for counting the number of touches made on key 5. The counter is reset after each setting of the mode. The counted result is used for selecting one of the characters assigned to key 5.

At step S24, it is detected whether or not the set mode is a hiragana mode.

At step S25, one hiragana character is selected from a plurality of hiragana characters assigned to key 5. The selection is done in a similar manner to the selection of one alphabet.

At step S26, it is detected whether or not the set mode is a katakana mode.

At step S27, one katakana character is selected from a plurality of katakana characters assigned to key 5. The selection is done in a similar manner to the selection of one alphabet.

At step S28, it is detected whether or not the set mode is a function mode, such as a content sensitive assistance mode.

At step S29, one function or assistance is selected from a plurality of functions or assistances. The selection is done in a similar manner to the selection of one alphabet.

At step S30, the selected character or function is output.

If the set mode is an alphabet mode, and key 5 is touched for the second time, the program goes from step S22 to S23 and the alphabet “K” is output from step S30. Then, at step S4, if the display assist mode is set, the pop-up display 110 of “K”, such as shown in FIG. 8, appears on display 100 for a predetermined time. Then, at step S6, if key 5 is depressed, the pop-up display 110 is cleared and the information “K” enters into the system. The entered information of character “K” appears at the regular display

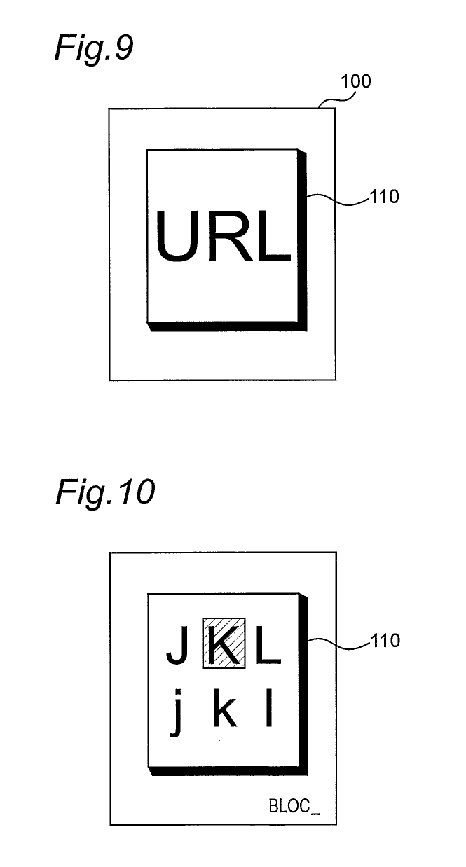

If the set mode is the content sensitive assistance mode, and key 5 is touched for the fifth time, the program goes from step S28 to S29, and the selected function “URL” is output from step S30. Then, at step S4, if the display assist mode is set, the pop-up display 110 of “URL”, such as shown in FIG. 9, appears on display 100 for a predetermined time. Then, at step S6, if key 5 is depressed, the pop-up display 110 is cleared and a page for entering the “URL” address appears as the regular display (not shown).

The above description is directed in connection with key 5, but other number keys 1, 2, 3, 4, 6, 7, 8, 9 and 0 are arranged in the same manner.

According to the present invention, other style of pop-up display can be employed, such as shown in FIG. 10, in which all or some of the characters assigned to the key appear together, and the selected character is high lighted.

According to the present invention, the item to be shown as the pop-up display is one of the follows:

a) the indicator, such as the number and the character(s) shown on the face of the key;

b) the number assigned to the key under numeral mode;

c) the character assigned to the key under character mode, which may be alphabet mode, hiragana mode, katakana mode, or any language character mode; and

d) the function assigned to the key under function mode.

Such an item to be shown as the pop-up display is generally referred to as a representing information which represents the touched key.

According to the present invention, at step S1, it is detected whether or not the key is touched. Instead of the detection of “touch”, it is possible to detect “depress”. In this case, the detection of “depressed” at step S6 should be changed to the detection of “enter-key depressed”. An enter key is a key other than the numeric keys.

According to the present invention, the data for the pop-up display can be stored in memory 103 in a look-up table format, or in a matrix format, or in a mapping format.

### INDUSTRIAL APPLICABILITY

The present invention can be used in the data input method and apparatus.

1. A method for inputting data to a system having a plurality of keys and a display, each key being indicated with a particular visual indicator, said method comprising:
detecting a touch on one of said plurality of keys;
displaying on said display, in response to the detection of a touch on one key, a pop-up display of a representing information representing the touched key;
detecting a depression of the touched key; and
entering data assigned to said touched key.

2. A method as claimed in claim 1, wherein said representing information is the indicator.

3. A method as claimed in claim 1, wherein said representing information is a number assigned to the key.

4. A method as claimed in claim 1, wherein said representing information is a character assigned to the key.

5. A method as claimed in claim 1, wherein said representing information is a plurality of characters assigned to the key.

6. A method as claimed in claim 1, wherein said representing information is a function assigned to the key.

7. A method as claimed in claim 1, further comprising, after data entering, displaying on said display, in response to the detection of depress, a regular display in which the entered data is displayed together with previously entered data.

8. A method as claimed in claim 1, wherein said pop-up display is displayed for a predetermined period of time.

9. An apparatus for inputting data to a system having a plurality of keys and a display, each key being indicated with a particular visual indicator, said apparatus comprising:
a touch detecting arrangement operable to detect a touch on one of said plurality of keys;
a displaying arrangement operable to display on said display, in response to the detection of a touch on one key, a pop-up display of a representing information representing the touched key;
a depression detecting arrangement operable to detect a depression of the touched key; and
an entering arrangement operable to enter data assigned to said touched key.

10. An apparatus as claimed in claim 9, wherein said representing information is the indicator.

11. An apparatus as claimed in claim 9, wherein said representing information is a number assigned to the key.

12. An apparatus as claimed in claim 9, wherein said representing information is a character assigned to the key.

13. An apparatus as claimed in claim 9, wherein said representing information is a plurality of characters assigned to the key.

14. An apparatus as claimed in claim 9, wherein said representing information is a function assigned to the key.

15. An apparatus as claimed in claim 9, wherein said displaying arrangement further displays on said display, in response to the detection of depress, a regular display in which the entered data is displayed together with previously entered data.

16. An apparatus as claimed in claim 9, wherein said pop-up display is displayed for a predetermined period of time.
